(19) United States
(12) Patent Application Publication
(10) Pub. No.: US 2007/0158411 A1
(43) Pub. Date: Jul. 12, 2007

(54) Method and system for storing, retrieving and updating information from an information card

(75) Inventor: Clifton Krieg JR., Reston, VA (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Eye Q Development, Inc.

(21) Appl. No.: 11/604,893

(22) Filed: Nov. 28, 2006

Related U.S. Application Data
(60) Provisional application No. 60/739,916, filed on Nov. 28, 2005.

(51) Int. Cl. G06K 5/00; G06Q 10/00

(52) U.S. Cl. 235/380; 705/2

(57) ABSTRACT

The invention is directed to methods of and apparatus for storing, retrieving and updating information on an information card or calling card. The card is made of traditional materials with at least a first surface reserved for traditional print and/or graphics. A second surface of the card contains computer readable storage media permanently affixed to the card. In another embodiment the card may be made from plastic materials and include an RFID tag as the electronic storage media. The storage media contains an electronic version of the printed text from the first surface of the card and other information. Information stored on the computer readable storage media can be read from the card using a magnetic reader or other card reader. Updated information card data may stored on a remote computer and accessed by card-recipients via the Internet. The information cards may be used in various systems including use as emergency tags, residential information tags, vehicle tags, and retail tags.

### CROSS REFERENCE TO RELATED APPLICATIONS

This application claims priority under 35 U.S.C. § 119(e) from U.S. Provisional Patent Application Nos. 60/739,916, filed on Nov. 28, 2005, which is incorporated herein in its entirety by reference.

### STATEMENT REGARDING FEDERALLY SPONSERED

### RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates generally to methods of and apparatus for storing, retrieving and updating information on an information card or tag and methods of using magnetic signatures and other techniques for identification and data tracking purposes.

2. Description of the Related Art

The use of business cards and calling cards remains a principal means of exchanging contact information in today's business society. Providing cards with pre-printed names (such as an individual and company name), physical addresses, electronic addresses, phone numbers, fax numbers, web site URLs, and other relevant information provide a convenient way ensure the card-giver's information is accurately provided to the recipient. Cards are typically exchanged at meetings, conventions, sales calls and any other face-to-face exchange. Cards are also frequently included in mailings to customers and prospective customers.

These business and calling cards are frequently collected by the recipient and stored for future reference. Some may store the cards in a physical library. One problem of storing a physical library of business or calling cards is the difficulty in arranging the card information. For example, cards may be ordered by individual name, company name, or product category. But, unless excessive copies are made, only one of these selected categories can be used for each card.

As an alternative to a physical card library, computer software is available that facilitates establishing and maintaining an electronic library of business cards. Use of most software programs, however, require manual keying of the card information into a database which then can be accessed to permit sorting in numerous categories and to limit searches to particular data fields. Manual keying of data can be time consuming, inefficient, and frequently inaccurate. Thus, there has been a continuing pursuit of more effective means to transfer business card information onto electronic media.

Computer scanning systems provide another possible means for creating an electronic information card library. One use of computer scanners requires scanned images of business cards to be stored onto a computer memory. While stored images provide some advantages, such as eliminating the need for a paper copy of the business card, the stored images have many of the same disadvantages as a physical card library. A particular drawback is that the images do not allow for sorting by multiple categories. Other computer software technology, such as optical character recognition (OCR) technology, can convert text from scanned business card into computer data. However, many business cards include corporate logos, stylized text, graphic images and other non-text features to enhance the recognition of the card. OCR technology generally performs poorly when converting non-traditional text or a combination of standard text and non-text features that are common on business cards. Furthermore, OCR technology is not well-suited for automatically assigning scanned text into appropriate software data fields. So, although the information from a particular scanned card may be stored on the computer memory, the information may still require user input to properly categorize the information.

There is therefore a need to provide an improved method for storing and retrieving information on a business card which eliminates the need to handkey data or rely on computer scanning of card text.

As an alternative to manual keying or scanning of card information, various electronic business cards have been developed. These electronic business cards generally require a card reading system that can read information from an electronic storage unit (such as a magnetic strip) on the card. Use of a reading device allows for automated data transfer from the business card into, for example, a card-recipient's database. The electronic business cards may contain the information of a traditional business card and potentially more or different information. Also, the electronic portion of the cards can be modified with updated information.

A drawback of traditional business cards and calling cards is that they become obsolete or inaccurate when the card-giver's information changes. Cards with inaccurate information must be discarded and replaced or altered. Furthermore, previous recipients of now-obsolete cards may not have sufficient information for the recipient to contact the card-giver. While the Internet provides a convenient means to provided access to updated personal and business information, privacy and security concerns have discouraged some from relying on internet-based systems. Thus, there remains a need in the art for an electronic business card system that allows users the optional convenience to make information accessible over the Internet, without requiring Internet use.

In marketing efforts, sales representatives may typically provide numerous business or calling cards during, for example, conventions or other events. Allowing a sales representative to track distribution of and possible interest in circulated business cards can provide valuable information for additional targeted marketing. There could be additional benefit to the ability of to track a card-giver's marketing success. For example, a manager could see at what particular events/locations his sales force had success and which card-givers appeared to generate more interest. Thus, there remains a need in the art to provide better data and use tracking mechanisms for business cards.

It is known in the art that magnetic media have unique, deterministic, remnant noise characteristics that can be identified and authenticated. The microscopic structure of the magnetic medium itself is a permanent random arrangement of microfeatures and is therefore deterministic. Each particle or grain in the magnetic medium is hundreds to thousands of Angstroms in dimension. Due to their small size, a small region of the magnetic surface will contain a very large number of these physical entities. While the fabrication process normally includes efforts to align these particles, there is always some dispersion of individual orientations. The actual deviations will be unique to a region of the medium's surface making this orientation a signature of that medium. The permanent random arrangement of microfeatures may be identified as a “magnetic signature” for a wide variety of magnetic media, including magnetic strips used to store information. To reproduce this distribution is basically impossible since this would entail a precise manipulation of the orientation of innumerable particles at the submicrometer level. Thus, the orientation of a large set of particles on a specific portion of a magnetic surface can uniquely identify that medium. U.S. Pat. Nos. 5,428,683, and 5,920,628, for example, discloses methods and apparatus for identifying and later authenticating the magnetic signature of various electronic media.

Regarding data management for medical and emergency applications, the vast majority of first responder and emergency room visits occur without any prior knowledge of a patient's records or prior conditions. This can lead to errors from misdiagnosis or lead to redundant testing. Prescribing or administering drugs to a patient without knowledge of a patient's allergies or other drug sensitivities may also create problems that prove harmful to the patient and require additional counter-measures. It would be beneficial to have a system to access essential medical information for care recipients at the place and time of first contact to allow medical personal to more effectively administer care.

In the area retail sales, the ability to track retail consumer purchases for marketing and sales incentives is a continuing need for many businesses. If an individual can be associated with the purchase of a particular product, the maker or distributor of that product can target the consumer for further sales through means such as directed advertising or incentives. In some instances this type of information can be gathered through surveys of consumers or product registrations after purchases have been made. However, response rates of such efforts are generally limited to a small percentage of the actual purchasers. Businesses can benefit from a more effective means of associating a purchaser's information with their product at the point of sale.

There are numerous uses and benefits of such information. For example, some credit cards are associated with particular brands that offer reward programs where “points” are accumulated based on purchases made with that credit card. Purchases of a particular brand or group of brands made with these credit cards may be given additional points credit (“bonus points”). However, in order for these bonus points to be properly assigned the consumer is typically restricted in how purchases of branded products are made or the consumer is required to register such purchases separately from the purchase.

In a typical example, a consumer may want to purchase a particularly branded electronic device and seek to obtain bonus points by using a credit card associated with that brand. In order to receive credit for the purchase, the consumer could use his brand credit card to purchase the device directly from the brand's direct distributor (through, for example, a website or catalog). Using this purchase method, the type of purchase (e.g., one eligible for bonus points) can be confirmed at the time of purchase and the consumer's account can be credited without additional effort from the consumer. If, however, the consumer purchases the same branded electronic device using the same credit card at a general retail store, the eligibility of the purchase for bonus points cannot be determined at the time of purchase. Thus, the consumer is required to submit proof of the purchase at a later point in time.

Similarly, when reward points are redeemed (e.g., for discounts on branded products), the consumer is again limited to either purchasing products directly from the brand's direct distributor or later submitting proof of purchase for eligible products purchased at a general retail store. The additional step that requires consumers to submit a proof of purchase to register or redeem reward points for eligible purchase can serve as a disincentive for consumers' use of these reward programs.

It would be beneficial to provide means to track and determine reward points for eligible credit card purchases at the point of sale at general retail stores that eliminates this burden from participating consumers. More generally, there remains a need for distributors to associate purchaser information with their products at the point of sale.

Thus, there remains a need in the art for improved comprehensive information management tools and methods that facilitate the sharing information in remote locations and updating of that information as required.

### SUMMARY

Accordingly, the invention is directed to methods of and apparatus for storing, retrieving and updating information on an information card or tag in conjunction with information stored on a remote database. The card may be made of traditional materials with at least a first surface reserved for traditional print and/or graphics. A second surface (or interior) of the card contains computer readable storage media permanently affixed to the card. The storage media may contain an electronic version of the printed text from the first surface of the card and other information. The computer readable storage media may be in the form of a magnetic strip, a radio frequency identification (“RFID”) tag, or other suitable technology that can be affixed to a card. Such other information need not be limited to traditional business card data. For example, aspects of the invention include use of a variety of electronically stored information, such as credential information, resumes, sales presentations, bios, pictures, technical information, chemical structures, prospectus medical directives, medical information, allergies, blood types, specific wishes for care, retail product information, etc. Information stored on the computer readable storage media can be read from the card using a card reader. The card reader may be operationally connected to a computer system with a database that can store and manipulate data read from the card. The card reader may also be a remote device that stores data from a card on a memory device, with the ability to later transfer that data to other readers or to other computer systems. The remote card reader may also include one or more mechanisms to manipulate card data.

In some embodiments of the card reader, an integrated controller may be included. The controller includes, for example, a screen, flash memory, and data entry mechanisms to allow a user to revise or add information to that which is read from an electronic information card. Another feature of the reader, in some embodiments, includes the ability to store additional information or alter existing information on the magnetic strip or other electronic storage media of an electronic information card.

Another feature of the electronic information card is that the electronically stored information can be changed without replacing card. In one embodiment, the printed (visual) card information may be limited to the most basic information (such as company name and/or individual name), so that the electronic card information can be updated without conflicting with the printed information. The printed card information may also include instructions for accessing additional electronic information stored on the card.

In another embodiment of the present invention, the various electronic information tracking and identification fuictions described above are made possible by use of a radio frequency identification (“RFID”) tag which can be affixed to or embedded in the electronic information card, so that the card can be read by an RFID reader. As with the magnetic strip described above, the RFID tag may be written to in order to store additional or updated information. Additionally, reading of the card with the RFID tag provide an indication of use to the card giver when the RFID reading system is connected to the Internet. The invention also provides techniques for shielding the RFID tags from unintended radio frequencies. Several advantages of RFID tags exist, but the present invention also provides alternative means for making devices for the above functions. Other suitable technologies suitable for electronic information cards and other card uses in accordance with the present invention include programmable memories like EPROMS, EEPROMS.

Another aspect of the present invention includes an electronic information card system that includes a remotely accessible data storage system. The remotely accessible data storage system my be, for example, an Internet accessible and/or web-based application linked to a database that allows individuals to update or add to their personal information. Rather than storing business and personal information consistent with the visual information on the electronic information card, the magnetic storage media contains a URL for a web-site with updated information specific to the card-giver. Thus, a card-givers information can be updated even after the card is distributed to a recipient.

Another feature of the present invention includes computer software in the card reader or the controller to permit a card recipient to add to the stored information from the electronic information card. Such information may include, for example, the time and location where the card was received. In another aspect of the invention the card reader includes an internal clock so that the time the card data was read will be automatically entered into the stored data in the reader's flash memory. Additionally, the reader can be equipped with a global positioning system (GPS), or other location identifying system, so that the location of the reader at the time the card is read can also be automatically entered into the reader's memory and associated with the information read from the electronic information card.

In one aspect of the present invention, a self-contained, portable electronic information card system is configured to receive data from an electronic information card having information stored on a computer readable storage media affixed to at least one side of the card. The electronic information card system comprises a card reader configured to accept the electronic information card and read the electronic information, and a controller operationally connected to the card reader to form the self-contained, portable electronic information card system. The controller is configured to receive the computer readable data from the card reader and to store the computer readable data.

In another aspect of the invention, the invention features a business contact information management method. The information management method includes steps of collecting information from a first electronic information card user, storing information related to the first user in a remotely accessible database operatively coupled to a remote computer, transferring some or all of the information from the first electronic information card user to an electronic information card, and enabling a card recipient to access the remote database over a network using a second computer to retrieve additional information related to the first user by entering information stored on the electronic information card.

The step of collecting information can include assigning a unique data group number to the collected information. The step of transferring may include a step of including the unique data group number in the data transferred to the electronic information card. The step of storing information may further include maintaining a chronological record of changes to the first user's information. The method can further include steps of establishing a second database of user information in the second computer, and updating information in the second database of the second computer by accessing information in the remote database. The second computer can access the remote computer, for example, over the Internet. The method can further include a step of enabling the first user to access the remote computer over a network using a first computer to edit the information related to the first user stored in the remote database.

In general, the above method enables a card recipient to collect, store and manipulate information from the first electronic information card user in any desired location or on any desired system. Recognizing that such information about the first user may eventually change or become obsolete, the method enables the card recipient to access the remote database to confirm at any later time accuracy of the information that was originally transferred from the first user's electronic information card. The first user may access the remote database (using for example, a secure Internet connection or other remote networking techniques) to update his business information at any time. The card recipient can search for and identify changes from the information that was originally transferred on the electronic information card by using the chronology of changes stored on the remote database or by using the unique data group number associated with the first user's information.

In another aspect of the invention, the remote database is accessed through a web site allowing card recipients and/or customers to access their personal data. Also, clients may have a unique web page to manage their account and data, thus eliminating the need for a local database to store contact information. Using the card reader while connected to the internet, a card recipients may automatically transfer a card-givers information into the recipient's private remote database.

In a particular embodiment, the invention utilizes a passive, inexpensive, disposable, non-contact, non-volatile read/write radio frequency identification (“RFID”) tag to store and transfer information. The RFID reader/writer communicates with a CPU of the system. Software resident on the CPU of the system in turn may interface and communicate with other systems like a local area network (LAN), information management software, as well as the Internet and the Web and other Internet—and Web-based applications. A reader/writer could interface to an RFID tag via, among other techniques, inductive coupling (e.g., by using an antenna) or capacitive coupling (e.g., by using conductive carbon ink that picks up electrostatic charges from reader). RFID tags from a variety of known manufacturers such as, for example, Texas Instruments, Motorola, Philips, Mitsubishi, Intermec, Micron and SCS may be used with this invention.

In particular embodiments of the present invention, the amount of data that can be stored in on a electronic storage media is large enough such that each single electronic information/identification card has a unique, individual identification number (or other indicia) as well as other relevant contact or other information. Having enough data storage capability on a tag to assign a unique number to each individual card as it makes its way from a card-giver to a recipient who uses the card to read or transfer the electronic information enables the creation of powerful databases providing real-time data to improve the efficiency of, for example, marketing or emergency management systems. Unique card identification may also be provided through the use of magnetic signatures on the cards, as described herein.

Each card can have a unique account number in a field of data stored on the electronic memory strip of the card to provide the ability to track each and every card. For example, when the card recipient uses the reader (while connected to the Internet) the card number may be read and an indication that the particular card was used can be provided to the card giver. Once a card is swiped through a reader (while connected to the Internet) the card recipient's web page will come up to access their personal account page. When not connected to the Internet, the card recipient can manage the data they have on their computer hard drive or other memory for future use.

An exemplary use of this aspect of the invention would be allowing a sales representative to track distribution of and possible interest in circulated business cards. A sales representative, for example, who hands out twenty cards to a vendor exhibit can track via the web site how many of the cards were scanned by the card recipients, provided the recipients have a card reader/writer and scan it through the web site. Another benefit of this aspect of the invention will be the ability of to track a card-giver's marketing success. For example, a manager you could see at what particular events/locations his sales force had success and which card-givers appeared to generate more interest.

A variety of other uses may be enabled by the present invention. In one aspect, the business card be a laminated plastic card, similar to a credit card or other magnetic cards known in the art. In other embodiments, the laminated plastic card may be reduced in size, for example to be suitable for use on a key chain. The cards and card readers may be designed with secure reading means or with proprietary distribution to allow personal information to be carried on the card without risk of inadvertent disclosure. As noted above, electronically stored card information may expand beyond or expand upon visual information contained on the card.

In one embodiment, for example, the card may include written identification information for a child, such as a name and home phone number. Electronically stored information may expand upon this data to include for example, a home address, guardian information, blood types, insurance providers, primary care physicians, social security number, or other information that may be relevant to emergency personnel. Proprietary card reading equipment and/or security codes on the card can be used to prevent unwanted access to card information. However, authorized users, such as police and medical personnel, can be equipped with card reading systems to obtain necessary electronic information from the card. While a physically separate card, such as a key chain card or standard-size credit card, may be used, other embodiments may include having the card embedded in a child's clothing or clothing tags.

In a similar manner, the card may also be used, for example, for credentials for military or other service personnel, where information on standard identification tags can be supplemented with electronic data such as medical information, care directives, or other data that could be accessed by authorized personal with secure equipment. Animal identification tags or collars may be used following principles similar to those outlined above.

In another exemplary embodiment, the electronic card may be used to provide residential home information. The card could be embedded in a mail box associated with a residence or, for example, near the address number on the residence itself. Unlike some of the previous embodiments, this embodiment would include a specialized hand-held reader that moves over the residential card, rather than requiring that the card itself be moved. The card stores electronic data using magnetic strips, RFID tags, EPROMS or any other suitable data storage media. The card system could be used, for example, by emergency personnel to identify basic home information in the event of a fire or other emergency. Because the information would be encoded and accessible only with proprietary or restricted equipment, the personal information can be made available to authorized personnel without exposing residents to an unwanted invasion of privacy. The card may include, on the visible surface, general information such as the house address number and/or residents' surnames. Electronic information may include, for example, the number and age of the residents or other information that may be useful to fire or other emergency personnel.

Another embodiment involves the use of the electronic card on regulated vehicles, such as cars, trucks, motorcycles, or boats. Electronic information may be included on license plates, stickers, or required decals. An exemplary application of this embodiment would be in the area of law enforcement. To assist in protection officers in the field (such as a police officer or coast guard officer) during routine stops, an officer could electronically scan a vehicle's electronic memory strip prior to confronting the vehicle operator. The electronic information could include the vehicle information number and/or local department of motor vehicles information that would identify the proper driver. If that information did not coincide with the officer's visual impression, the officer could take appropriate measures.

Embodiments of the invention also provide a novel retail tag, tag-reading system, and methods for using same. The tags can be attached to retail products or product packaging to help associate purchaser information with the purchased products at the point of sale. The retail tag includes computer readable information that can be read by a tag reader at the time of purchase. The computer readable information may be, for example, in the form of a magnetic stripe on the tag or an RFID chip embedded in the tag. The tag reader may be a separate reader, specific for the novel tags, or, alternatively, the reader may be a combined reader that can be used for traditional credit card purchases as well as read the retail tags.

Tags may be affixed to the retail products by conventional means, such as, for example plastic tie-lines using in the clothing industry. Another means for affixing the tags may include use of a sealed plastic cover to secure the tag to, for example, a box, so that the tag can be removed (if necessary) and scanned at the point of sale. These methods of tag attachment are not intended to be limiting, and other methods of attachment are contemplated as being within the scope of the present invention.

In one aspect the invention provides, a method of providing and accessing electronic health records, including the steps of (a) providing an electronic information card to a recipient, where the electronic information card includes both visual printed information and stored computer-readable information, the visual printed information and stored computer-readable information being relevant to at least one of the health of the recipient and electronic access of additional information about the recipient; (b) storing health information of said recipient on a separate database operatively coupled to a remote computer, at least some of said health information corresponding in part to the stored computer-readable information; (c) reading the computer-readable information from the electronic information card using a card reader operatively coupled to the computer; and (d) accessing said database from the remote computer using the information relevant to electronic access of additional information of the recipient computer-readable information stored on said electronic information card.

In another aspect, the invention provides an electronic information card system. The system includes (a) an electronic information card having visible information and information stored on a computer readable and computer writeable storage media affixed to the card; (b) a card writer configured to receive user data and input the data onto the computer readable and computer writeable storage media; (c) a card reader configured to accept the electronic information card and read the electronic information; (d) a first computer configured to receive the computer readable data from the card reader and to store the computer readable data; and (e) a database operatively coupled to the first computer to allow said first computer to display the user data, the database storing the user data and adapted to receive changes to the user data.

Another aspect of the invention provides a method of managing contact and other business information. The method includes (a) collecting information from a first electronic information card user; (b) storing information related to the first user in a remotely accessible database operatively coupled to a remote computer; (c) transferring some or all of the information from the first electronic information card user to an electronic information card; and (d) enabling a card recipient to access the remote database over a network using a second computer to retrieve additional information related to the first user by entering information stored on the electronic information card.

Accordingly, the invention is also directed to methods of and apparatus for using magnetic information cards in a variety of applications, including providing emergency health information; tracking business card and marketing efforts; and retail sale information.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the figures:

FIG. 1 provides an illustration of the front side of an electronic information card in accordance with one embodiment of the present invention;

FIG. 2A provides an illustration of the back side of an electronic information card in accordance with one embodiment of the present invention;

FIG. 2B provides an illustration of a cross section of an electronic information card in accordance with one embodiment of the present invention;

FIG. 3 provides an illustration of the electronic card reading system in one embodiment of the invention;

FIG. 4 provides an illustration of the electronic card reading system in accordance with another embodiment of the invention;

FIG. 5 provides a block diagram showing one embodiment of a computer system used in embodiments of the present invention;

FIGS. 6A-6C provide a method for operating a contact management system in accordance with an embodiment of the present invention;

FIGS. 7A-C provide schematics of information management systems in accordance with embodiments of the present invention;

FIG. 8 provides a flow chart of a method for using an information management system in accordance with an embodiment of the present invention;

FIG. 9A provides an illustration of the front side of a retail sales tag in accordance with one embodiment of the present invention; and

FIG. 9B provides an illustration of the back side of a retail sales tag in accordance with one embodiment of the present invention.

### DETAILED DESCRIPTION OF THE INVENTION

Reference will now be made in detail to the preferred embodiments of the present invention, examples of which are illustrated in the accompanying drawings.

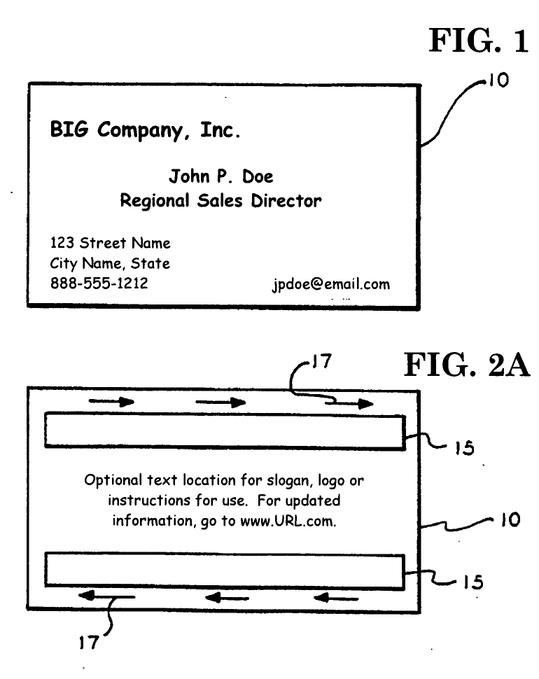

FIG. 1 illustrates the front of an electronic information card 10, with traditional card information printed thereon including the name of the company, the name of the representative, the title and email address of the representative, and the address and telephone number of the company. The card 10 is made from paper or equivalent material for traditional business cards, so as to be inexpensive and disposable. In other embodiments disclosed herein, the cards may be made of plastic, laminated material, or other more rugged material.

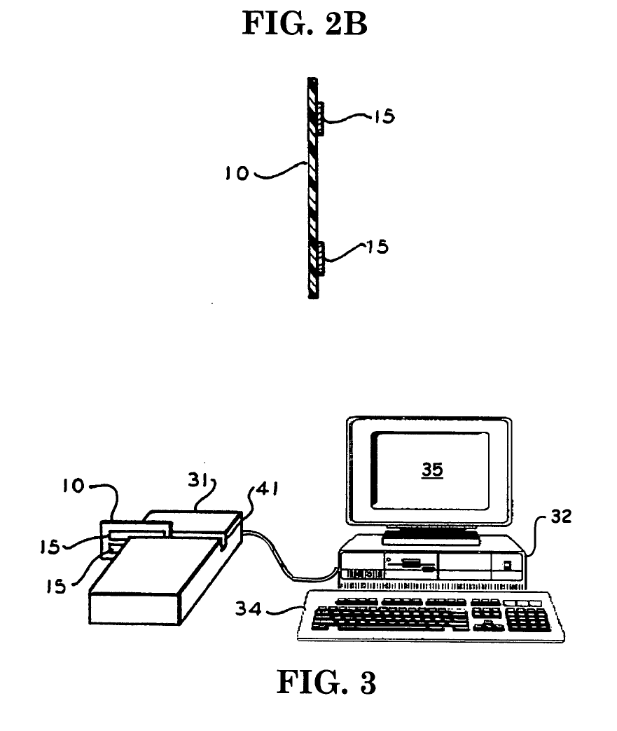

FIG. 2A illustrates the back side of the electronic information card 10 which includes computer readable storage media strips 15. The strips 15 are secured to the back side of the card 10 so as to not adversely effect the data storage characteristics of the strips 15. The strips 15 may be a magnetic tape on which data may be encoded by magnetic means, for example. While the strips 15 are shown extending across the horizontal width of the back side of the card 10, other configurations and amounts of strips are contemplated. For example, a single strip 15 may be used. In the embodiment shown, the strips 15 can be read by moving the card in a direction 17, relative to a reader. Alternatively, the strip may be in a non-linear shape. Such non-linear shapes could be used to form symbols, marks, or other identifiable logos associated with information on the card 10. As shown in FIG. 2A, use of additional printed text on suitable portions on the back side of card 10 is also contemplated.

FIG. 2B provides a cross sectional view of the electronic information card of FIGS. 1 and 2, showing the card 10 and strips 15 secured to the back of the card 10. The strips 15 may be adhesively affixed to the surface of the back side of the card 10. Alternatively, the strips 15 may be partially or completely embedded into the surface of the card. In yet another alternate embodiment, the electronic information card may be formed from a plurality of layers, where the front surface of the card 10 may be made of paper material (or equivalent) that serves as the visibly readable face of the card, and a layer of an encodable material forms a back surface of the card for storing electronic data. A middle bonding layer may also be included between the front and back layers of the card. While magnetic strips are shown in the present embodiment, it is contemplated that other computer readable storage media, such as RFID tags, could be used.

The data stored on the electronic information card may include the same information printed on the front of the card. The electronic information card may also include additional information, such as a website address or information about an event where it was handed out. Another embodiment assigns a unique serial number to each electronic information card, which is stored on the card's storage media. This unique serial number allows for tracking business cards for more effective marketing. As explained below, when an electronic information card is read by a computer, some embodiments access a remote database in order to download information. When the remote database is queried, information about the query, including the serial number of the electronic information card, can be recorded.

Another embodiment makes use of magnetic signatures to provide a way to track each card. Magnetic indicia on the card, which may be in the form of a magnetic strip 15, magnetic ink or other form, will provide an inherently distinct magnetic signature. Some embodiments use a unique serial number or similar means to identify individual business cards. Such systems may also incorporate card identification through use of magnetic signatures. The magnetic signature can be identified as part of the printing process and converted to digital format. The magnetic signature provides a unique card identification that can be recorded on the card itself and/or in a database for future tracking in accordance with embodiments of the present invention, as described above.

In another embodiment card information may be tracked according to embodiments of the present invention using a bar code and bar code scanning system. In this embodiment, the electronic information card has a bar code on the back (not shown) that encodes the serial number of the information card. The bar code can be scanned in and the remote database queried, as described below.

FIG. 3 is an illustration of the electronic card reading system which includes a card reader 31 coupled to a computer 32 which includes a keyboard 34 and display screen 35. Information from the card 10 can be read by passing the card through the reader 31. The reader 31, includes a card path 41 with one or more reading heads (not shown) adjacent to the card path that detect and read the encoding on the strip 15 when the card 10 is drawn past the reading head by either manual or automated means. The card data read by the reader 31 may be transferred from the reader 31 to memory within in the computer 32 or to a separate memory device (not shown) external to the computer 32. The card may either be retained by the recipient or disposed of, if desired. The system may also include a printer (not shown) so that a printed copy of the data on the business card may be made.

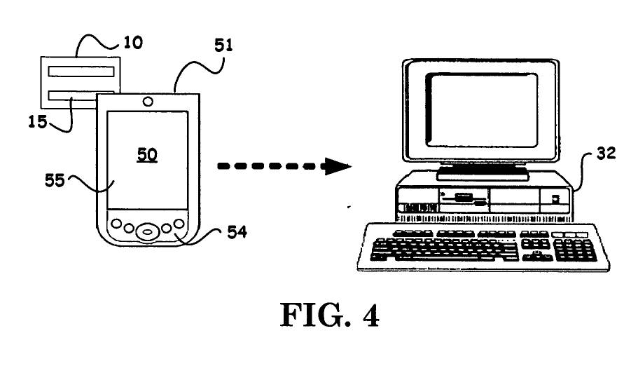

FIG. 4 is an illustration of the electronic card reading system which includes a remote card reader 50 with an integrated controller and memory device (not shown), a viewing screen 55, a data entry means 54, and a card path 51 located along the top of the card reader 50. The reader 50 has one or more reading heads (not shown) adjacent to the card path 51 that detects and reads the encoding on the strip 15 when the card 10 is drawn past the reading head by either manual or automated means. The card data read by the reader 50 may be transferred from the reader 50 to memory within in the remote card reader 50. The card data may also be transferred to a separate memory device or external computer 32.

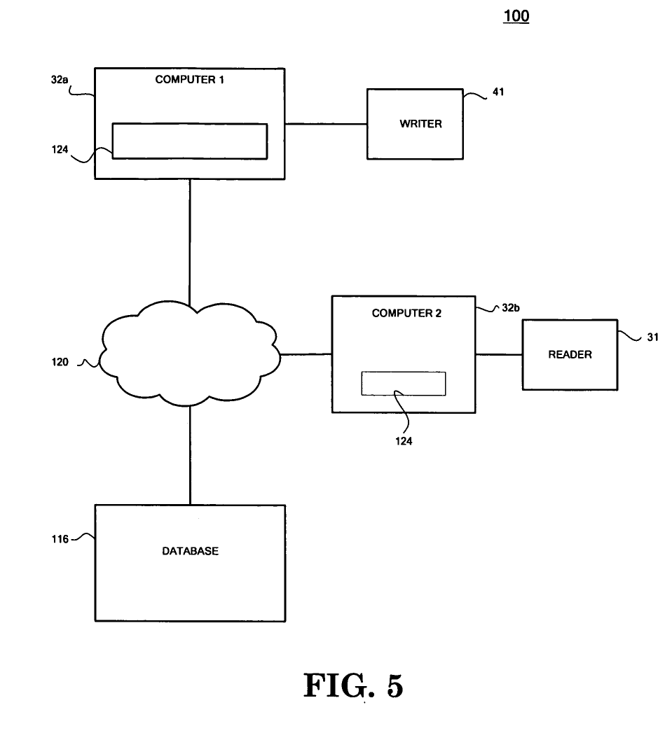

Embodiments of the present invention will now be described with reference to FIG. 5. FIG. 5 shows a computer system 100 functioning as an information management system in accordance with one embodiment of the present invention. The electronic information card system 100 includes a first personal computer 32a, a second personal computer 32b, and a remote database 116. The first computer and the second computer are coupled to the remote database 116 over a network 120. In one embodiment of the present invention, the network 120 includes the Internet, and the remote database 116 includes a web server and is accessible over the Internet. The remote database 116 has an assigned uniform resource locator (URL) to allow the personal computers to access the remote computer over the Internet. The first computer 32a and the second computer 32b contain a web browsing software that enables the computers to access the remote database 116 over the Internet using the URL of the web site, as is known in the art. Moreover, a URL can include parameters for the remote database in order to query contact information, so that an appropriate URL for requesting a specific person's contact information from the remote database 116 may be stored on an electronic information card. The web browsing software may be one of several known proprietary internet browsers such as Microsoft Internet Explorer® or open source browsers such as Mozilla Firefox®.

In other embodiments, the first and second personal computers may be coupled to the remote computer over a private dedicated computer network or the first and second personal computers may access the remote computer over a standard network connection using a modem or similar device.

The first computer 32a is operationally connected to a card writer 41 that is capable of writing electronic card information onto electronic information cards. Information that a card-giver desires to be stored on the card is copied from the first computer 32a onto the electronic information card 10 using card writer 41. The second computer 32b is operationally connected to a card reader 31 that is capable of reading electronic card information from electronic information cards. Alternatively, the second computer 32b is configured to synchronize with a remote card reader 50 (not shown). When the card 10 is given to a recipient, the recipient may use reader 31 associated with the second computer 32b to transfer the electronic card data to memory within second computer 32b. In one embodiment, the reader 31 can be equipped with a global positioning system (GPS), or other location identifying system, so that the location of the reader at the time the card is read can also be automatically entered into the reader's flash memory and associated with the information read from the electronic information card. Time stamps are also contemplated.

As shown in FIG. 5, the second personal computer 32b includes a controller 124 that may act as a bridge between the card reader 31 and one of a number of personal information programs, such as (by way of illustration only) Microsoft Access, Oracle Database, and Microsoft Outlook, that allow a user to maintain a database of contact information. In an alternate embodiment, controller 124 may allow connection to the remote database 116, so that a card recipient's contact list can be stored and accessed on the remote database. In this embodiment, the card giver's information could be accessed using a secure website account (including, for example, password protection). This query would use the serial number of the electronic information card, as described above. In another embodiment, the remote database 116 stores the serial numbers of all business cards that are used to request information. Once an electronic information card 10 is read by the card reader 31, the controller 124 can then use appropriate software to store, add to, and manipulate the card data.

As shown in FIG. 5, the first personal computer 32a includes a controller 124. This allows the first personal computer 32a to write card data from a personal information program or the remote database 116, as described above, to the card writer 41.

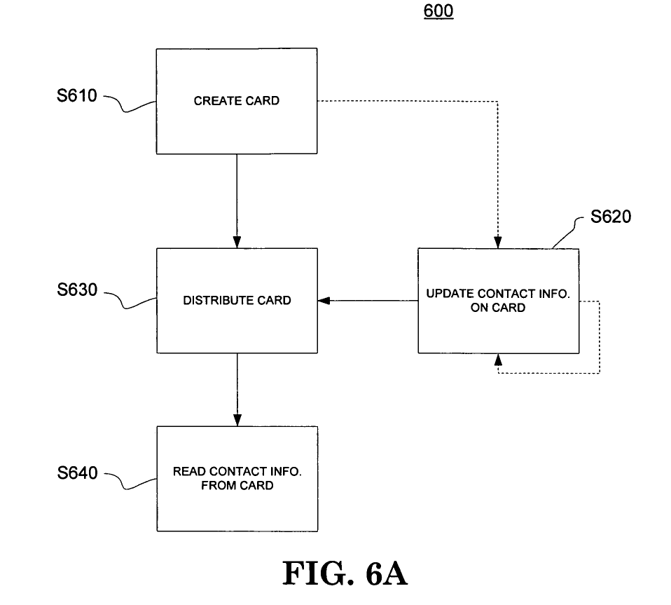

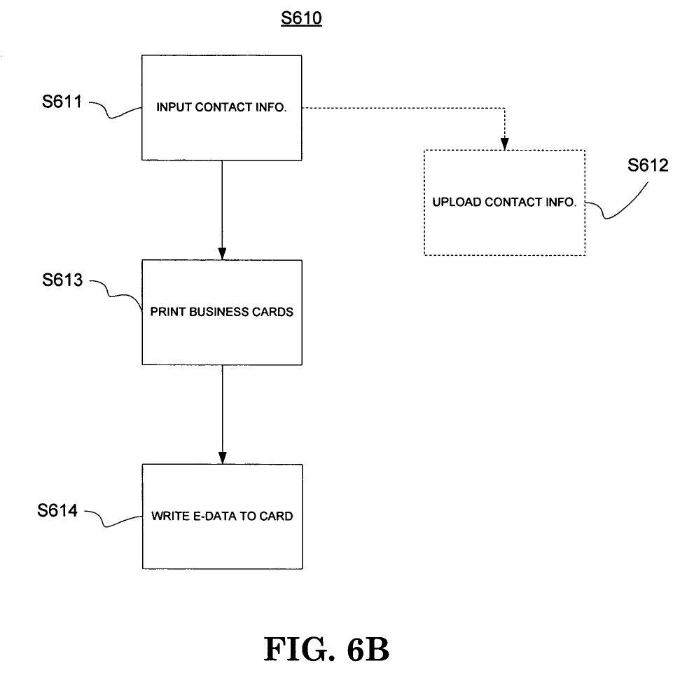

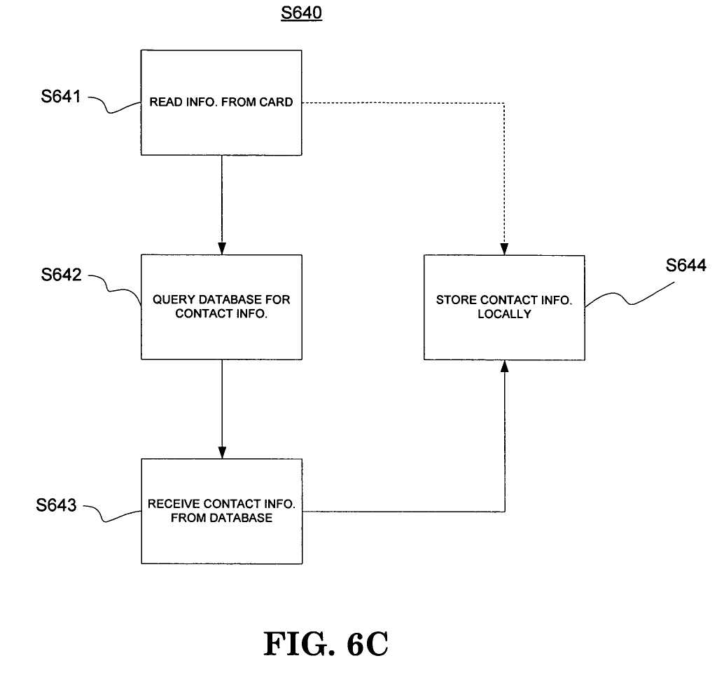

FIGS. 6A-6C provides a general method 600 in accordance with one embodiment of the present invention for operating the information management system 100 to implement a contact management system. As shown in FIG. 6A, in a step S610 of the method, a user (hereinafter the card-giver) creates an electronic information card (shown in detail in FIG. 6B). It is possible that the card-giver's information will change over time and need to be updated. In optional step S620, the card-giver updates the information on the card. In step S630, the card-giver distributes the card to a second user (hereinafter the recipient). Finally, in step S640, the recipient reads the card giver's contact information from the electronic information card (shown in detail in FIG. 6C).

FIG. 6B shows the steps needed to accomplish step S610 (as shown in FIG. 6A). In step S611, the card giver uses the first personal computer 32a to input business contact information (or other relevant information) of the card-giver into the computer memory. This may be accomplished using a personal information program or other data entry program. In some embodiments, business contact information is stored in a remote database 116. In step S612, the contact information entered in step S611 is uploaded to the remote database 116. In a separate step S613, the card-giver (or a commercial printer selected by the card-giver) prints electronic information cards for the card-giver. As described above with respect to FIGS. 1-2, the cards 10 contain printed information and computer readable strips 15 to store electronic data. In step S614, the card-giver uses the personal computer 32a and the writer 41 to write the contact information entered in step S611 onto the electronic information card 10 printed in step S613.

At some point in time, information on information card 10 may become inaccurate or obsolete. The same process described in FIG. 6B, omitting step S613 (because no new card needs to be printed), may be used to update information on a information card 10 in step S620 (from FIG. 6A).

FIG. 6C shows the steps to read contact information from the electronic information card (step S640 from FIG. 6A). In step S641, the recipient uses a personal computer 32b and a card reader 31 to read information from the electronic information card. As explained above, the electronic information card may store contact information, or it may store a URL for obtaining updated contact information. If the electronic information card stores contact information, that contact information is read in step S641 and stored locally on personal computer 32b in step S644. If the electronic information card stores a URL, in step S642 the remote database 116 is queried using that URL. In some embodiments, the query will include a serial number of the electronic information card, which will be stored by the remote database 116. In step S643, the personal computer 32b receives contact information from the remote database 116. In step S644, this contact information is stored locally on personal computer 32b.

In the embodiment of the present invention described above, the computer system 100 has two users. As understood by those skilled in the art, other embodiments of the present invention may include computer systems having many more users than two, and the web database may contain contact information for a large numbers of users.

In particular embodiments of the present invention, the amount of data that can be stored in on a electronic storage media is large enough such that each single electronic information/identification card 10 has a unique, individual identification number as well as other relevant contact or other information. Having enough data storage capability on a card to assign a unique number to each individual card as it makes its way from a card-giver to a recipient who uses the card to read or transfer the electronic information enables the creation of powerful databases providing real-time data to improve the efficiency of, for example, marketing or emergency management systems. Unique card identification may also be provided through the use of magnetic signatures inherent to the cards.

A variety of other uses may be enabled by the present invention. In one aspect, the information card be a laminated plastic card, similar to a credit card or other magnetic cards known in the art. In other embodiments, the laminated plastic card may be reduced in size, for example to be suitable for use on a key chain. The cards and card readers may be designed with secure reading means or with proprietary distribution to allow personal information to be carried on the card without risk of inadvertent disclosure. As noted above, electronically stored card information may expand beyond or expand upon visual information contained on the card.

The card 10 may include in one embodiment written identification information for a person (a child, for example) such as a name and home phone number. Electronically stored information may expand upon this data to include for example, a home address, guardian information, blood types, social security number, or other information that may be relevant to emergency personnel. Proprietary card reading equipment and/or security codes on the card can be used to prevent unwanted access to card information. However, authorized users, such as police and medical personnel, can be equipped with card reading systems to obtain necessary electronic information from the card. For example, licensed emergency persons may use a proprietary reader (such as, for example, a magnetic card reader or RFID tag reader) to read information relevant to emergency care (such as, for example, a card holder's blood type and allergies), but may be restricted from accessing other secure information stored on the card. While a physically separate card, such as a key chain card or standard-size credit card, may be used, other embodiments may include having the card embedded in a child's clothing or clothing tags.

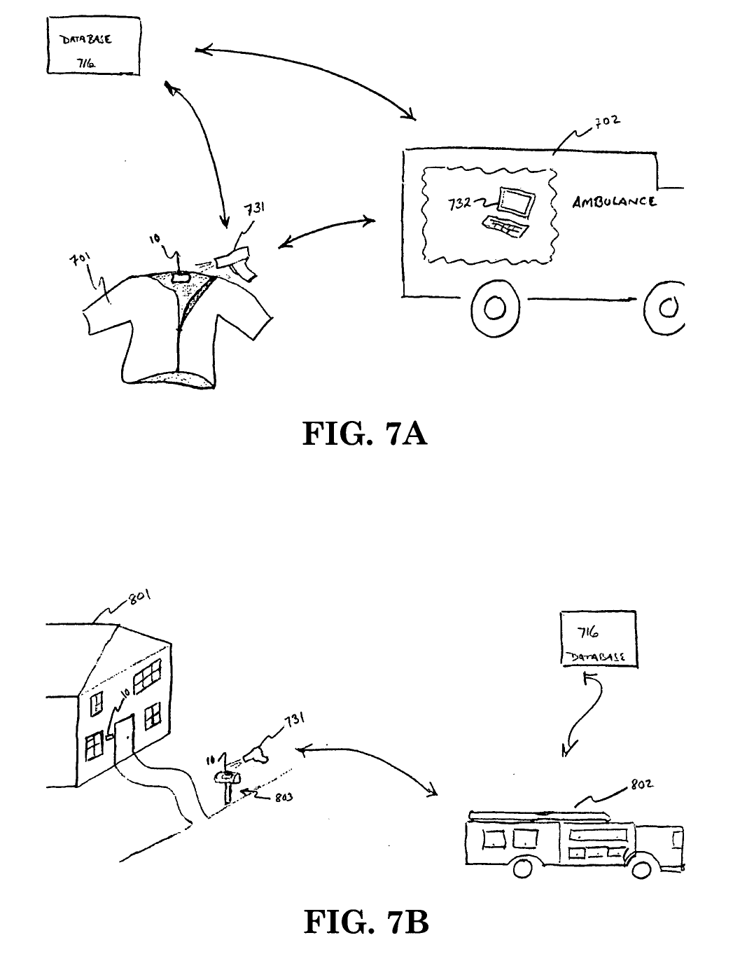

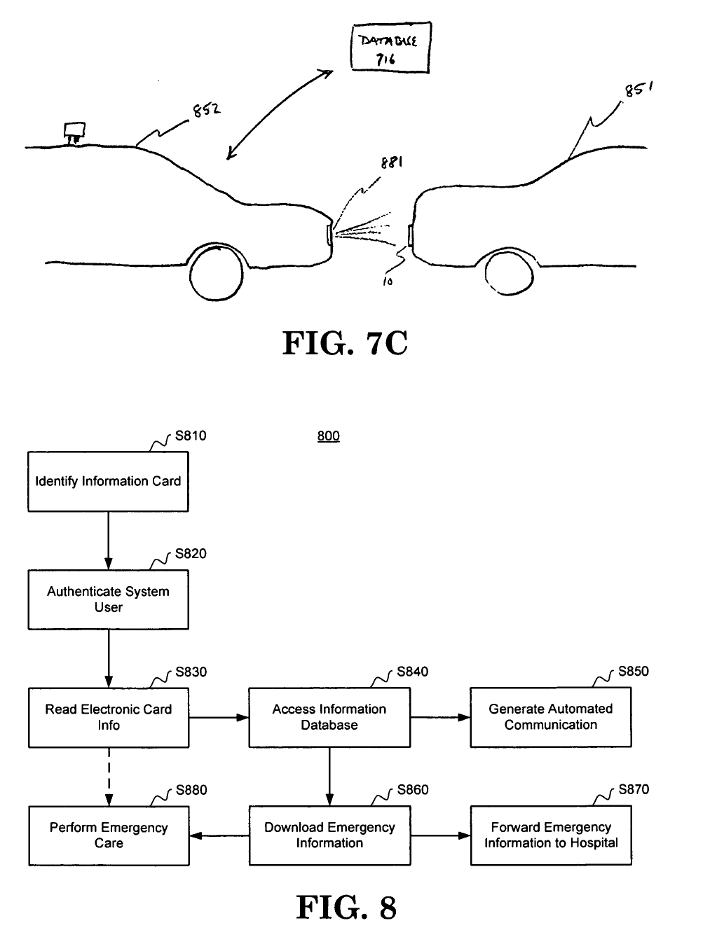

In the embodiment shown in FIG. 7A, an information card 10, is attached to an article of clothing 701 to be worn by the person associated with the information on the card 10. The card 10 may include both printed and electronically stored information. In an emergency situation, emergency personnel may use a reading device 731 to obtain some or all of the electrically stored information. The reading device 731 may be a hand-held device as shown, or alternatively, the reader may be incorporated into a system on a mobile computer unit (not shown). The stored information may be viewed on the screen (not shown) included on the reader 731 and/or audibly projected by the reader. Information from information card 10 may also be transferred via a wired or wireless connection to a computer system 732, which may, for example, be included in an emergency response vehicle 702. The computer system 732 may be connected to a remote database 716 by, for example, a wireless Internet connection. The database 716 may be used to confirm whether the information retrieved from information card 10 has been updated or whether additional information may have been added to the card holders' profile. Alternatively, reading device 731 may be equipped with wireless communication capabilities to access remote database 716 directly.

Using the system of FIG. 7A, a first responder team, responding to an emergency involving the person associated with the information on the card 10, would be able to assess the person/patient and simultaneously scan (using reader 731) the card 10 for emergency-related health information that was previously stored on the card 10. Based on the condition of the patient and information health information provided on the card, emergency personnel can begin to take appropriate action to care for the patient. Meanwhile, information that the reader 731 collected from card 10 can be verified by operatively connecting to the remote database 716. In some embodiments, the reader 731 may contain wireless connectivity so as to directly communicate with database 716. In other embodiments, the a separate computer system 732 may be used to communicate with database 716. While patient information may be stored on card 10 in some embodiments, in other embodiments card 10 may serve as an integrated access portal to a remote database containing the cardholder's information. In other words, the electronic information on the card 10 may be limited to the credential information necessary to access stored information about the cardholder from a remote database. While the card 10 is described in FIG. 7A for use with a patient, the card 10 may also be included as standard equipment for emergency personnel.

In yet another embodiment, emergency personnel (such as firefighters, for example) may be equipped with cards 10 when reporting to an emergency scene. Cards may (for example) be affixed or embedded in one or more item of each person's clothing and serve as credentials for each emergency personnel. Using a centralized reader and an optional computer system, the cards may be used to register each person arriving on the scene. The computer system and/or reader may record each person's arrival and thus provide information to account for emergency personnel throughout the course of the emergency. As describe in previous embodiments, the information cards 10 for each person may contain identification information, as well as select health information that may be helpful to medical professionals in the event of an injury to that person. In this and other embodiments, the cards 10 may be equipped with redundant systems, such as, for example, both a magnetic strip and an RFID chip, to increase flexibility and compatibility with multiple systems.

The card 10 could also be used, for example, for identification tags for military and other personnel, where information on standard identification tags can be supplemented with electronic data such as medical information, care directives, or other data that could be accessed by authorized personal with secure equipment. Animal identification tags or collars may be used following principles similar to those outlined above.

As shown in FIG. 7B, another exemplary embodiment, the electronic card may be used to provide residential home information. The card 10 could be embedded in or affixed to, for example, a mail box 803 associated with a residence 801 or in an accessible location (e.g., near the address number) on the residence 801 itself. This embodiment would include a specialized reader 731 that, for example, moves over the residential card, rather than requiring that the card itself be moved. The card 10 stores electronic data using magnetic strips, RFID tags, EPROMS or any other suitable data storage media. The card system could be used, for example, by emergency personnel to identify basic home information in the event of a fire or other emergency. Because the information would be encoded and accessible only with proprietary or restricted equipment, the personal information can be made available to authorized personnel without exposing residents to an unwanted invasion of privacy. The card 10 may include, on the visible surface, general information such as the house address number and/or residents' surnames. Electronic information may include, for example, the number and age of the residents or other information that may be useful to fire or other emergency personnel. As described with respect to reader 731 of FIG. 7A above, the reader 731 of FIG. 7B may transfer data from the card 10 via a wired or wireless connection to a computer system (which may be included for example in emergency vehicle 802) for verification and/or additional information stored on remote database 716.

Referring to FIG. 7C, another embodiment involves the use of the electronic card on regulated vehicles, such as cars, trucks, motorcycles, or boats. Electronic information may be included on license plates, stickers, or required decals of a vehicle. As shown in FIG. 7C, an exemplary application of this embodiment would be in the area of law enforcement. To assist in protection officers in the field (such as a police officer or coast guard officer) during routine stops, an officer in a patrol car 852 could electronically scan a stopped vehicle's 851 electronic information card 10 prior to confronting the vehicle 851 operator. A reader 881 may be integrated into the law-enforcement vehicle 852 or, alternatively, may be a hand-held reading device. The electronic information could include the vehicle information number and/or local department of motor vehicles information that would identify the proper driver. If that information did not coincide with the officer's visual impression, the officer could take appropriate measures. Optionally, reader 881 may communicate directly with database 716 to verify or update data read from information card 10. Each of the embodiments described above may utilize the information network techniques described above with respect to FIGS. 5 and 6A-6C to update or verify data on the information card 10.

FIG. 8 provides a flow chart of a method for using an information management system in an emergency situation (such as, for example, an electronic health record system) in accordance with an embodiment of the present invention. The method 800 describes steps that may occur in a typical emergency response scenario, such as, for example, an EMT responding to an automobile accident. Upon arriving on the accident scene, in step S810, emergency response personnel identify the patient and conduct a search for an information card that may be located on the patient's clothing or elsewhere on the patient. The information card may be in the form of a standard card shape, a tag, or a non-traditional card shape. The card may (as described in the embodiments above) include one or more of a magnetic strip, RFID chip, or other device to store electronic data. Depending on the type of electronic storage device on the information card, the information card may be identified by visual recognition or simply by an electronic scan in the vicinity of the card, such as a scan by an RFID reader, for example.

Still referring to FIG. 8, the user of the system, e.g., the emergency personnel, must be granted access to the personal information of the patient. Some personal information may be stored on the card's electronic storage media, while additional information may be stored in a remote database. The personal information stored on the information card may be limited to information required to access the cardholder's personal information stored in the remote database; but other information (including information that may be redundantly stored on the remote database) may also be stored on the information card. To ensure privacy of the card holder, user authentication may be required before accessing any of the electronic information stored on the card. However, in other embodiments, the information available on the information card may be limited enough to defer user authentication until the point when the remote database is accessed. Thus, in step S820, the emergency personnel registers as an authenticated user of the information system (e.g., the electronic health record system). In one embodiment, the registration may be conducted through use of the user's own electronic information card (e.g., their credentials), which may be electronically read by the card reader and then confirmed, for example, by an additional password, security code, or other security mechanisms. Conventional secure login techniques (such as username and password, biometrics, voice recognition, etc.) may also be used.

In step S830, the electronic information card is read by the card reader, which may be any suitable reader for collecting electronic data from the storage media on the information card. Ideally, steps S810, S820, and S830 may be conducted in just a few seconds, and the sequence of these steps may be interchangeable. It is understood that traditional patient care procedures, such as efforts to stabilize a patient, may proceed simultaneously with the initial steps of the method 800. Depending on the information available on the card itself, the system user (e.g., the EMT) may have enough information at this point to confidently proceed with additional emergency care techniques for the patient, as shown in step S880.

In step S840, information obtained form the patient's electronic information card is used to access a remote database with, for example, electronic health records of the patient. The information available on the database may include information necessary for emergency care (e.g., known allergies, blood type, immunizations, and the like) as well as information concerning emergency contacts, primary care providers, and/or insurance information. If the patient's information card included health-related information, information from the card can be cross-referenced with information from the remote database for accuracy and/or currency. Other additional information of the patient (such as, for example, dental records, past medical history, immunization records, and the like) may be stored on the remote database; but access to this additional information may restricted through various techniques known in the art to, for example, only the patient or those designated by the patient. In step S860, information accessible to the emergency personnel may be downloaded. The downloaded information be stored in memory in the card reader and displayed on a screen on (or operatively connected to) the card reader. Additionally, the information may be sent to a printer in, for example, the emergency vehicle or integrated into the card reader to provide a paper copy for the user. Once the patient information has been downloaded to the emergency personnel, they may review the information and, in step S880, perform required emergency care as necessitated by the circumstances and guided by the patient's health information.

In step S850, the electronic health record system, upon being accessed by the emergency personnel may, optionally, generate an automated communication to contacts included in the patent's stored information. For example, in-case-of-emergency (ICE) contacts, primary care physicians, and/or insurance companies may be automatically notified. Such notification may include, for example, an indication that the patient's records were accessed, by whom they were accessed, contact information of the accessing party, and/or where to obtain additional information. The automated communication may be in the form of an email, text message, automated telephone message, or other method as enabled and/or directed in the patient's stored information.

In step S870, patient information may be forwarded to additional emergency institutions, such as a hospital to which the patient is being transported. Information may be relayed to the hospital by the emergency personal (e.g., orally) or forwarded as an electronic transmission of the information downloaded from the remote database in step S860. In other embodiments, information may be provided to the hospital as part of the automated communication of step S850 described above.

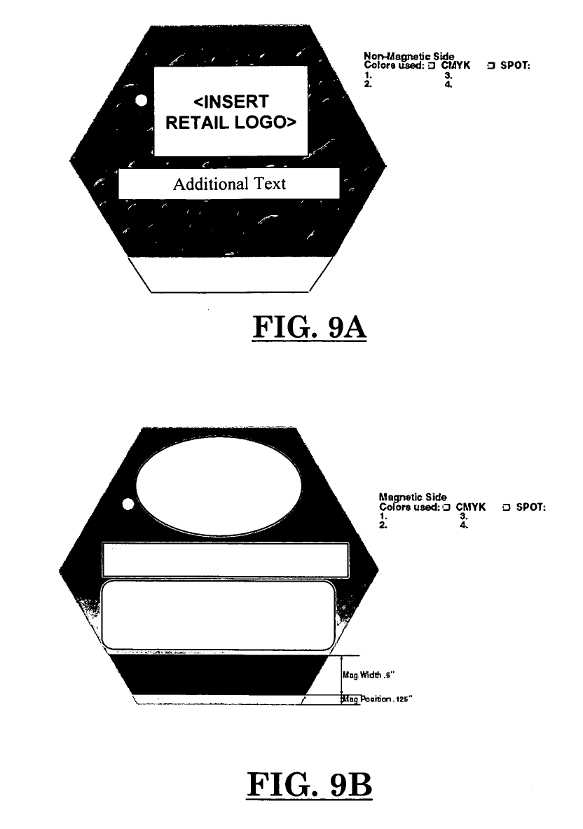

As shown in FIGS. 9A and 9B, the present invention also provides a novel retail tag, tag-reading system, and methods for using same. The tags can be attached to retail products or product packaging to help associate purchaser information with the purchased products at the point of sale. The retail tag includes computer readable information that can be read by a tag reader at the time of purchase. The computer readable information may be, for example, in the form of a magnetic stripe on the tag or an RFID chip embedded in the tag. The tag reader may be a separate reader, specific for the novel tags, or, alternatively, the reader may be a combined reader that can be used for traditional credit card purchases as well as read the retail tags. The tag reader may be equipped to read information stored on computer readable information and/or information about the information storage medium. More specifically, the reader may be equipped to identify the magnetic signature of magnetic information on the retail tag.

Tags may be affixed to the retail products by conventional means, such as, for example plastic tie-lines using in the clothing industry. Another means for affixing the tags may include use of a sealed plastic cover to secure the tag to, for example, a box, so that the tag can be removed (if necessary) and scanned at the point of sale. These means of tag attachment are not intended to be limiting, and other methods of attachment are contemplated as being within the scope of the present invention.

The retail tag may be made of traditional materials, such as card stock, laminated cardboard, or plastic, with at least a first surface reserved for traditional print and/or graphics. A second surface of the card-which may contain additional print information or graphics-contains computer readable storage media permanently affixed to the retail tag. The storage media may contain information such as a website, product descriptor, or other data. The computer readable storage media may be in the form of a magnetic strip, a radio frequency identification (“RFID”) tag, or other suitable technology that can be affixed to a retail tag. The other data need not be limited to traditional product information data. A sample retail tag, according to one embodiment of the present invention, is shown in FIG. 9A. Any number of tag shapes and configurations are contemplated. For tags with magnetic stripes, such as shown in FIG. 9B, configuration of the tag is limited only by the requirement to locate the magnetic strip so as to be readable by a card reader, typically along an edge of the tag. RFID-based tags, however, would have no such limitations.

Information stored on the computer readable storage media can be read from the tag using a tag reader, preferably at the point of sale. The tag reader may be operationally connected to a computer system that can store and manipulate data read from the tag. In one embodiment, the data from the tag is associated with the purchaser's credit card information at the time of purchase. The tag reader may also be a remote device that stores data from a tag on a memory device, with the ability to later transfer that data to other readers or to other computer systems.

The remote tag reader may also include means to manipulate tag data to, for example, indicate a completed sale of that product. The tag may also be used to collect data that can be associated with the purchase in real-time so as to provide information to the purchaser at the point of sale. For example, credit card reward information could be associated with a purchaser's account and reported on the bill of sale receipt for the purchase at the time of the transaction. In another example, a website address, coupon, access code, or other information specific to the retailer and/or tag provider could be included on the customer's receipt (or on a separate document provided simultaneously with the receipt).

Information from the retail tag that has been associated with, for example, a purchaser's credit card can be used to identify potential customers for further marketing efforts such as, for example coupons, directed advertising, credit card reward programs, frequent customer programs, or other marketing tools used by the retailer. The customer may be apprised of such marketing through, for example, credit card statements or through contact means provided in a customers credit card account (such as a mailing address or email account).

The present invention also contemplates a system for tracking and communicating purchase data collected from the retail tags of the present invention. As discussed above, the tag information may be associated with a users credit card information and thus associated with a particular consumer. Alternatively, tag information may be associated with the purchaser via nearly any form of electronic payment (e.g., debit cards, gift cards, RFID tags, electronic account numbers, or the like) or store-specific cards (e.g., membership cards) that are scanned at the point of sale. Alternatively, address information from payments by check may be associated with retail tag information at the point of sale by imaging the check. For cash purchases and other non-electronic transactions, a customer may be given the option of providing personal information (such as an address or phone number, or a member number of, for example, a rewards program).

While exemplary embodiments of the invention have been shown and described herein, it will be obvious to those skilled in the art that such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope of the claims, as they will be allowed.

I claim:

1. A method of providing and accessing electronic health records, comprising the steps of:
providing an electronic information card to a recipient, said electronic information card including both visual printed information and stored computer-readable information, said visual printed information and stored computer-readable information being relevant to at least one of the health of the recipient and electronic access of additional information about the recipient;
storing health information of said recipient on a separate database operatively coupled to a remote computer, at least some of said health information corresponding in part to said stored computer-readable information;
reading said computer-readable information from said electronic information card using a card reader operatively coupled to the remote computer; and
accessing said database from said remote computer using the information relevant to electronic access of additional information of the recipient computer-readable information stored on said electronic information card.

2. The method of claim 1, further comprising the step of modifying said computer-readable information on said separate database.

3. The method of claim 1, wherein the stored computer-readable information is stored on an RFID chip.

4. The method of claim 1, wherein the stored computer-readable information is store on a magnetic strip.

5. The method of claim 1, wherein the stored computer-readable information includes an identifier unique to the electronic information card.

6. The method of claim 5, wherein the identifier unique to the electronic information card is a magnetic signature.

7. The method of claim 5, wherein the identifier unique to the electronic information card is an alpha-numeric number.

8. The method of claim 1, further comprises the step of providing user authentication for said card reader prior to said step of reading said computer-readable information from said electronic information card.

9. The method of claim 8, further comprising the step of notifying at least one third party after said step of accessing said database.

10. The method of claim 9, wherein the at least one third party is a designated in-case-of-emergency contact.

11. An electronic information card system, comprising:
an electronic information card having visible information and information stored on a computer readable and computer writeable storage media affixed to the card;
a card writer configured to receive user data and input said data onto the computer readable and computer writeable storage media;
a card reader configured to accept the electronic information card and read the electronic information;
a first computer configured to receive the computer readable data from the card reader and to store the computer readable data;
a database operatively coupled to the first computer to allow said first computer to display said user data, said database storing said user data and adapted to receive changes to said user data.

12. The electronic information system of claim 11, wherein said electronic information card is a retail sales tag comprising information about a retail product associated with the tag.

13. The electronic information system of claim 11, wherein said electronic information card is an emergency identification card comprising information related to the card holder.

14. The electronic information system of claim 11, where said computer readable and computer writeable storage media is at least one of a magnetic strip and an RFID chip.

15. The electronic information system of claim 11, wherein said electronic information card is a business card comprising identification indicia unique to the electronic information card.

16. A method of managing contact and other business information, comprising the steps of:
collecting information from a first electronic information card user;
storing information related to the first user in a remotely accessible database operatively coupled to a remote computer;
transferring some or all of the information from the first electronic information card user to an electronic information card; and
enabling a card recipient to access the remote database over a network using a second computer to retrieve additional information related to the first user by entering information stored on the electronic information card.

17. The method of claim 16, wherein the electronic information card includes identification indicia unique to the electronic information card.

18. The method of claim 17, wherein the identification indicia unique to the electronic information card is stored in computer-readable format.

19. The method of claim 17, wherein the identification indicia unique to the electronic information card is a magnetic signature.

20. The method of claim 17, wherein the identification indicia unique to the electronic information card is a serial number.
